(19) United States
(12) Patent Application Publication
(10) Pub. No.: US 2013/0109555 A1
(43) Pub. Date: May 2, 2013

(54) MACHINE FOR ASSEMBLING CARDBOARD BOXES

(71) Applicant: Boix Maquinaria, S.L., San Isidro de Albatera (Alicante) (ES)

(72) Inventor: Jose BOIX JAEN, SAN ISIDRO DE ALBATERA (Alicante) (ES)

(73) Assignee: BOIX MAQUINARIA, S.L., San Isidro de Albatera (Alicante) (ES)

(21) Appl. No.: 13/723,316

(22) Filed: Dec. 21, 2012

Related U.S. Application Data
(63) Continuation of application No. PCT/ES2011/070266, filed on Apr. 15, 2011.

(30) Foreign Application Priority Data
Jun. 25, 2010 (ES) U201030663

(51) Int. Cl. B31B 3/02

(52) U.S. Cl. CPC B31B 3/02
USPC 493/84

(57) ABSTRACT

The invention relates to a machine for assembling cardboard boxes, including a device for feeding sheets of cardboard that are used to form the boxes in a forming station comprising an assembly device including a mold and a male element that descends by means of a vertical linear actuator, in order to form the box inside the mold, co-operating with the latter. The invention is characterized in that it comprises a frame (33) having a hollow surrounding structure that supports the feeder device which is removably connected to the frame (33) in a cantilevered manner.

### OBJECT OF THE INVENTION

The current invention as expressed in the title of this specification, relates to a machine for assembling cardboard boxes which presents the particularity of including a small space, practically the strictly required for placing the set of mold and male element of forming the box, thus achieving a complete forming device for minor productions and at a much lower cost than current machines on the market.

### BACKGROUND OF THE INVENTION

The forming and assembling of cardboard boxes is currently performed by means of machines or devices in which two fundamental elements exist; one defining a mold where the sheet is placed, from which said box itself is obtained, and another one defining a male element assembled with the ability of upward and downward displacement to push the sheet onto the mold and makeup the box in the latter, by perpendicular elevation of its sides and ends as well as folding its flaps and tabs.

The patent application ES200001620 relates to a device for making up and assembling cardboard boxes which falls within the type of devices as those described in the previous paragraph.

These machines and devices for making up cardboard boxes present the drawback of occupying large volume which negatively impacts transportation precisely due to the large space that they occupy.

### DESCRIPTION OF THE INVENTION

In order to achieve the objectives and prevent the aforementioned drawbacks, the current invention proposes a machine for assembling cardboard boxes that include in principle, a mold for making up the cardboard box inside thereof co-operating with a male element, whose descent makes up the final cardboard box through a stamped sheet, constituting the combination of the mold and the male element, an assembly device as the described for example in the patent application ES200001620 of the same owner as the current invention.

From this premise, the machine of the invention is characterized in that it comprises a frame that supports and houses the set of the assembly device, such frame adapting itself to the dimensions of the mold and male element of the assembly device, in such a way that all the elements are confined to this size of the frame suitably arranged, with the exception of a removable feeder device, in such a way that the latter is assembled after installing the set of the machine, said feeder device arranged cantilevered, at the same time as being adjustable to fit different dimensions of cardboard sheets from which the boxes are obtained.

Thus, the set of the assembled machine can be easily transported thanks to the characteristic frame, with the feeder device removed, a frame that houses the assembled assembly device, thus achieving to transport a larger number of machines in the space in which previously only one machine or at least a smaller number of machines could be placed.

The machine of the invention can be transported at a relatively low cost, being able to fit two machines in the space in which it is only possible to fit one conventional machine since all of the feeder device can be disassembled, as previously mentioned.

Another feature of the invention is the addition of pushing means included in the feeder device to automate the insertion of each cardboard sheet into the forming station where the assembly device (male element and mold) is located.

Such pushing means consist of a drag chain activated by a motor element for dragging the cardboard sheet to the forming station by means of a transversal pusher fixed to the said drag chain. It also includes a clutch and an encoder connected to the transmission of the drag chain, the encoder allowing for the adaption of the feeder device to different lengths of the cardboard sheet according to its dimensions. This dragging system operates as the one described in the patent application ES201030029 of the same proprietor as the current invention.

The frame is characterized in that it comprises a hollow structure that includes a lower part made up by a prismatic base that delimits an inside space housing the mold set and an upper part made up by two end supports and a transversal bridge connecting said end supports, the transversal bridge supports a headstock control and also the set of the male element.

With this described arrangement, the assembly device as well as the feeder device, and the rest of the elements of the machine, do not protrude from the sides of the frame, thus favoring the transportation of the machine upon occupying a reduced volume, in such a way that a number of machines for transportation can be positioned bringing them together until the sides of their frames are touching.

In an embodiment of the invention, the insertion assembly of the machine for assembling cardboard boxes of the current invention, comprises a fixed part and a movable part that moves on a guide for adapting the insertion assembly to a predetermined length. For this, the insertion assembly comprises a displacement spindle to carry out the movement of the movable part on the guide. Said displacement spindle comprises a first end connected to the fixed part by means of a plate positioned perpendicular to the fixed part. Also, the displacement spindle comprises a second end which is connected to the movable part and which also comprises an end element, it comprises a diametric groove adapted to receive a tool whose rotational movement displaces the mobile part on the guide, thus adjusting the distance between the fixed part and the movable part to the predetermined length.

In another embodiment comprising all the elements of the previously described embodiment, the insertion assembly additionally includes a set of suction pads, which is supported by a suction pads bracket attached to the guide.

Next, in order to facilitate a better comprehension of this specification and forming an integral part thereof, a set of figures representing the object of the invention in an illustrative rather than limitative manner accompany this specification

### BRIEF DESCRIPTION OF THE DRAWINGS

FIG. 1 shows a perspective view of the machine for assembling cardboard boxes object of the invention. It comprises basically of a frame supporting an assembly device and a feeder of the cardboard sheets for forming the corresponding boxes device. The assembly device comprises a mold and a male element.

FIG. 2 shows another perspective view of one part of the machine of the invention.

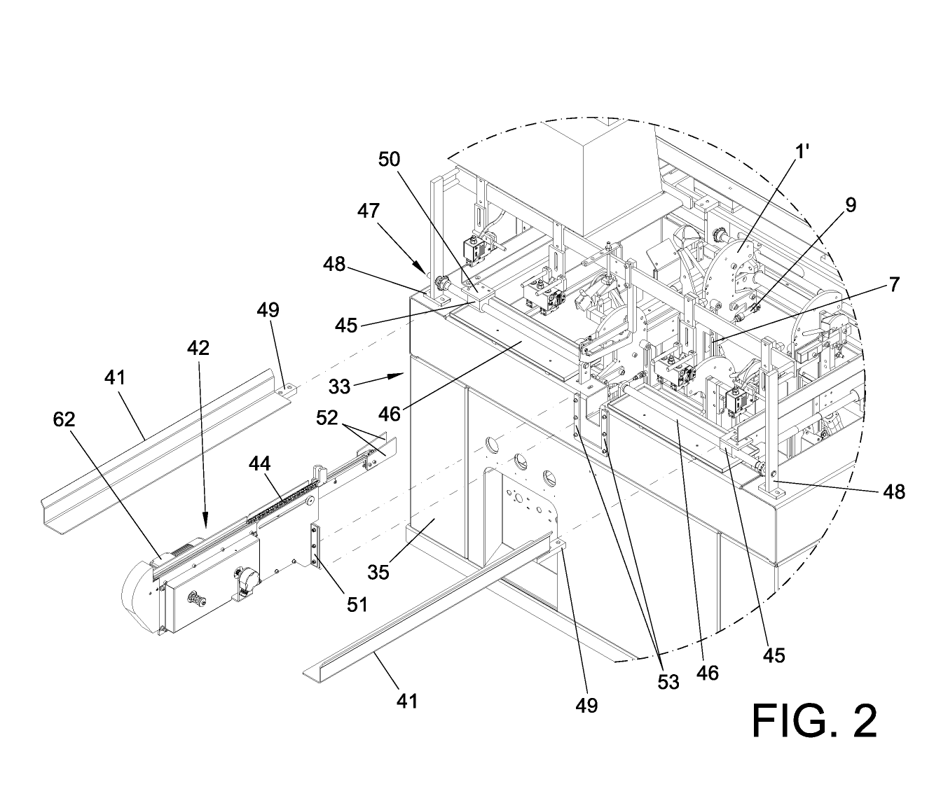

FIG. 3 shows a view of one part of the feeder device, through which the cardboard sheets are pushed toward the forming station, where the assembly device is located.

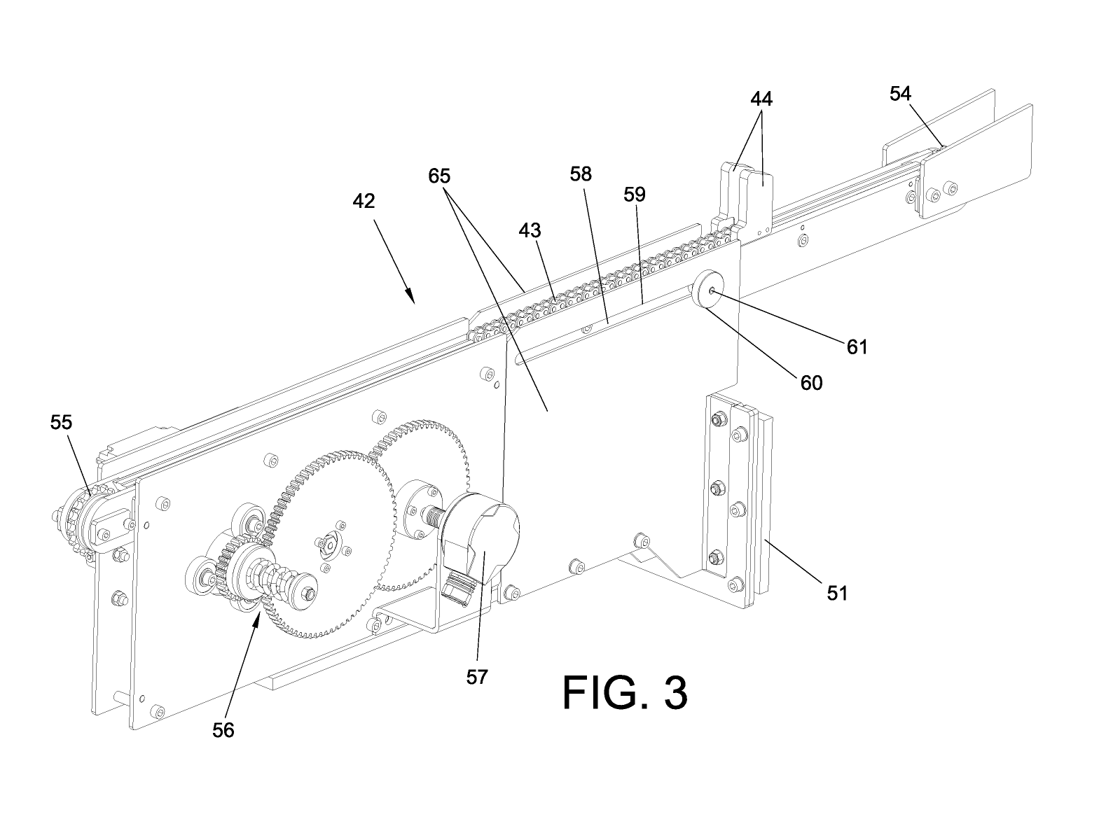

FIG. 4 shows a perspective view of the assembly device.

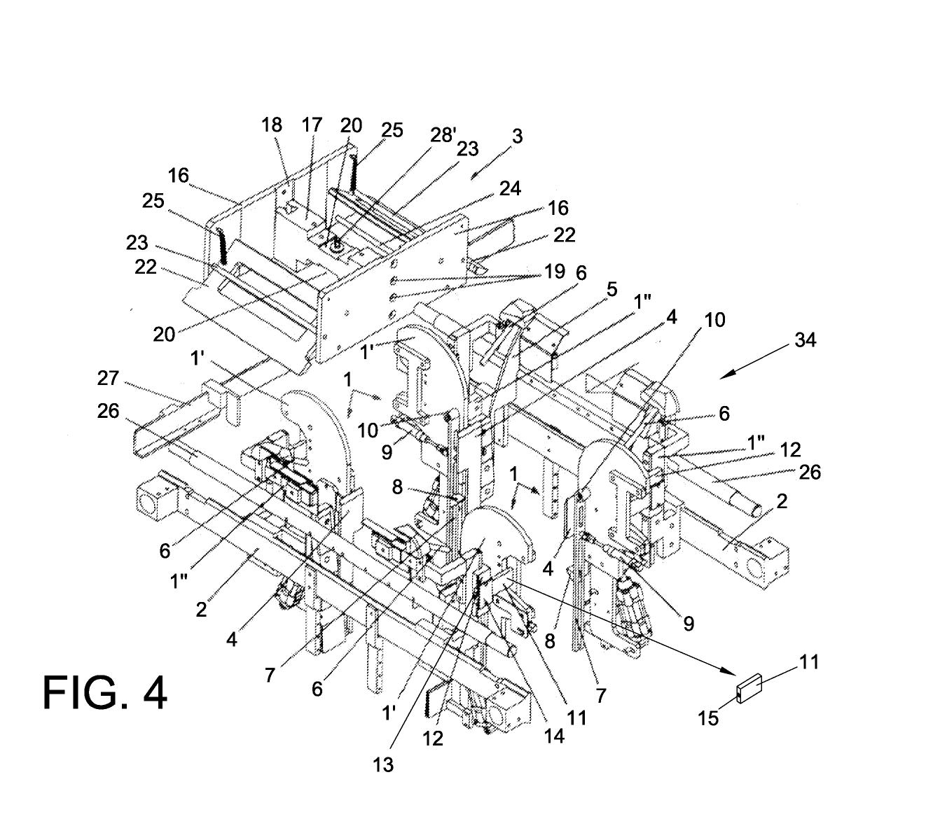

FIG. 5 shows a perspective view of one part of the male element of the assembly device and one part of the vertical linear actuator that moves the male element downward during the making up of the box.

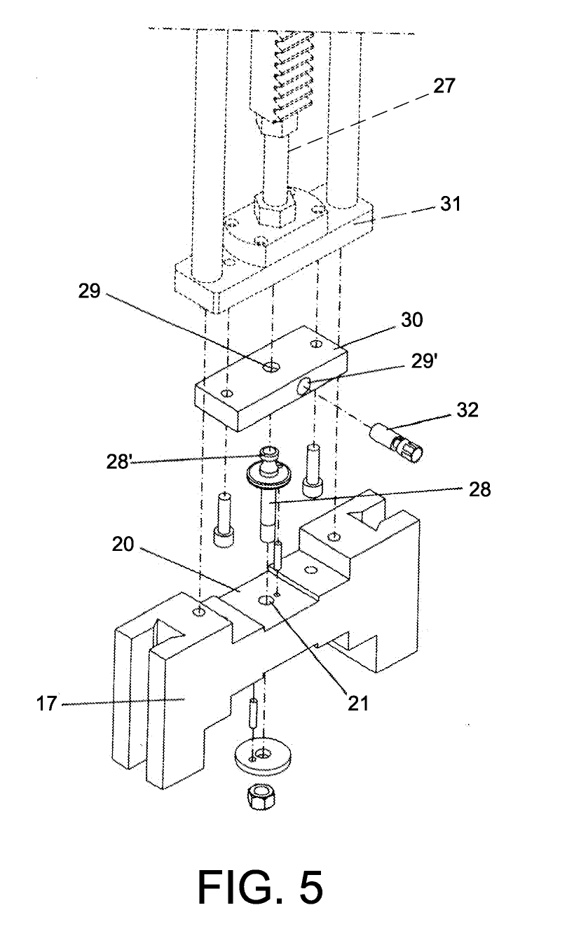

FIG. 6 shows a view of one part of the feeder device for manual loading.

FIG. 7 shows a view of one part of the feeder device for automatic loading.

FIG. 8 shows another perspective of the view shown in FIG. 7.

FIG. 9 shows a view of the current invention with a protective cover for an automatic load feeder.

### DESCRIPTION OF THE PREFERRED EMBODIMENT

Considering the numbers adopted in the figures, the machine for assembling cardboard boxes is determined from a characteristic frame 33 that supports a device for assembling boxes and a feeder for cardboard sheets device, from said cardboard sheets boxes are made up when they reach the forming station where the assembly device is located.

The assembly device is determined from a mold 34 formed by four corner elements 1 that are assembled on the lateral guides 2, from which the corner elements cannot be moved lengthwise. The assembly device is supplied with a male element 3.

Each one of the corner elements 1 comprises two parts: a front part 1′ and a back part 1′,’ the latter making up a support for the assembly and displacement of each corner element 1 on the corresponding lateral guide 2.

The mold 34 made up by the four corner elements 1, is designed to receive a stamped cardboard sheet, from which a box will be shaped and assembled, each corner element 1 containing flat pieces 4, constitutive of pushing means that pushes on the sides of the box being shaped, similarly including side flaps 5, as well as arms 6 constituted by a number of bars or cylindrical bars obliquely positioned and convergent by pairs to determine the folding means of the corresponding flaps and tabs of the ends of the box, and which are placed against the sides thereof, these bars or folding elements contribute furthermore in the elevation of the sides of the box being formed towards the perpendicularity of said sides.

On the front part 1′ of each corner element 1, in addition to the flat pieces 4, there is also a vertical guide 7, which includes a support 8 for the base of the box that is sliding, in order for the box to be held by these supports 8 and for the complete forming to be carried out, since previously the box has been formed by the male element 3. That is, in the support position of the box, the final forming operations are performed on the supports 8, as well as the folding of certain flaps and tabs.

When the box is completely assembled, its removal from the mold is achieved when it is released from the supports 8, as these supports 8 must retract, an operation that is performed by means of the tilting of the vertical guides 7, precisely where said supports 8 are located, a tilting which logically must be outward by action of a pneumatic cylinder 9 for each one of these supports, in such a way that the outward tilting of these guides 7, around the upper pivot point 10, the supports 8, will also be displaced outward allowing the assembled box itself to fall by gravity.

The variation of width of the mold that is made up by the corner elements 1, is achieved by combining the lengthwise movement of said elements 1 on the lateral guides 2 with the transversal movement thereof, in such a way that the second movement consequently achieves that the front part 1′ of each corner element 1 is movable by distancing and approaching with respect to the back part 1′ that constitutes the support of the assembly of the corner element itself 1. In such a way that the front displaceable part 1, has a flat bar 11 that acts as a shaft, the flat bar 11 is held in a displaceable way along one opening 13 set between a piece 12 of the back part 1″ and a closing plate 14. The housing of the flat bar 11 acting as a shaft of the opening 13 can be performed to a greater or lesser extent, and thus the front part 1′ standing more or less spaced from the back part 1″, involving an increase or decrease in the transversal direction width of the mold 34 made up by the abovementioned corner elements 1.

The flat bar 11 acting as a shaft of displacement of the front part 1, to regulate the position of front part with respect to the back part 1″, has on its free end a block that limits the maximum displacement of the flat bar 11 acting as a shaft on the opening 13 in which it remains inserted, so that it does not come out of the opening.

In turn, the male element 3, is made up by means of a pair of vertical plates 16, between which an intermediate bridge 17 is positioned which can be fixed between said plates 16 or have a variable positioning. In the latter case, the ends of this intermediate bridge 17 slide on internal guides 18 set on the vertical plates 16 for this purpose, being able to be fixed at any height by means of screws that fit through side holes 19 of the plates 16 and are fixed on a hole provided for this purpose on the ends or sides of said intermediate bridge 17.

However, the previously mentioned intermediate bridge 17 has a recess 20 affecting a large part of its length and enables the reversal of its position between the plates 16, thus varying the corresponding height of the set of the male element 3 in its assembly on the support of the machine, in which case, without adjustment means such as those previously defined, and with no more than varying the position of the intermediate bridge 17, two positions of the height of the male element 3 can be achieved.

Similarly, and for the purpose of enabling an easy disassembly of the male element 3, said intermediate bridge 17 has a front hole 21 in which a rod 28 with an upper head 28′ is housed, in which a central hole 29 of a flat bar 30 is housed, through which said intermediate bridge 17 is fixed to the front bracket 31 of the machine. The flat bar 30 has a transversal hole 29′ housing a bolt 32 with a lateral recess and a head with suitable means of handling, said bolt 32 being the one that blocks the upper head 28′ of the clamping rod 28 rotating and matching the area devoid of the lateral recess with said head 28′ having an annular constriction. The extensibility of the male element 3 is achieved as a consequence that between the lateral plates, both flaps 22 are assembled which can be rectangular with a central space, as shown in the figures, or can be configured in a “U” shape so that, in any case, these flaps are assembled through their ends or side edges in a pivotally way between the lateral plates 16, so that these can tilt a length upwards and downwards limited by both bars 23 and 24 set at different heights and offset on the vertical plane between the aforementioned plates 16, said flaps 22 being required to the fully extended position by means of springs 25.

In addition, the assembly device includes bars 26 on which various means and devices used for folding flaps and tabs of the shaped box can be assembled.

On the other hand, the frame 33 provides the support of the whole device for assembling boxes the latter being confined in said frame according to a top plan view of such frame 33, at the same time that part of the mold 34 of said assembly device is located in an inside space delimited by said frame 33.

This frame 33 has a surrounding structure including an upper part and a lower prismatic-rectangular part formed by four corner feet 35 connected by a lower frame 36 and another more robust upper structure 37.

The upper part of the frame 33 comprises two end supports 38 and a transversal bridge 39 that supports the assembly of the male element 3 and the vertical linear actuator 27 for displacing the male element 3 to shape the cardboard boxes from a cardboard sheet. The upper part also has a gluing system 40.

The feeder device comprises a removable structure formed by two cantilevered side rails 41 as guides for the cardboard sheet for shaping the boxes and an insertion set 42 that includes a drag chain 43 attached to a transversal pusher 44, by means of which each cardboard sheet is dragged to the forming station where the assembly device set is located.

The side rails 41 are removably attached by one of their ends to sliders 45 connected to both side threads 46 of a transversal spindle 47, in turn joined to end supports 48 integral with the upper structure 37 of the frame 33, in a way that upon rotation of said transversal spindle 47, the sliders 45 move closer together or are separated further apart depending on the direction in which the transversal spindle 47 rotates, dragging said sliders 45 to the side rails 41 in order to adapt to the width of the cardboard sheet.

The side rails 41 of the feeder device are fixed to the sliders 45 by end pieces 49 that are removably screwed onto flat seats 50 of said sliders 45.

On the other hand, the insertion set 42 is connected by vertical displacement to the upper structure 37 of the frame 33 by means of side lugs 51 connected to vertical guides 53 and by means of a front upper clamp 52 linked to the frame 33 above its upper structure 37.

The connection of the insertion set 42 by vertical displacement allows for a quick assembly and disassembly.

The positioning of the cardboard sheet with respect to the forming station is carried out displacing the whole insertion set 42 using opposite grooves 59 of two side pieces 65. Thus we move the transversal pusher 44 closer or further away with respect to the forming station, for the different lengths of the cardboard sheet.

The insertion set 42 is immobilized fixing its end section 58 in the appropriate position by means of side knobs 60 connected to thread lugs 61 joined to said end section 58 of the insertion set 42, the thread lugs 61 located in correspondence with the mentioned opposite grooves 59.

The transversal pusher 44 is joined to the drag chain 43, which itself is connected to two end sprockets: a front sprocket 54 and a back sprocket 55, and also to an inside tractor assembly in which there is a gear motor 62, also including a clutch 56 and an encoder 57 so that the connection between the latter and the transversal pusher 44 is never lost. All these elements make up a pulling mechanism as described in the patent application ES201030029 of the same proprietor as the invention at hand.

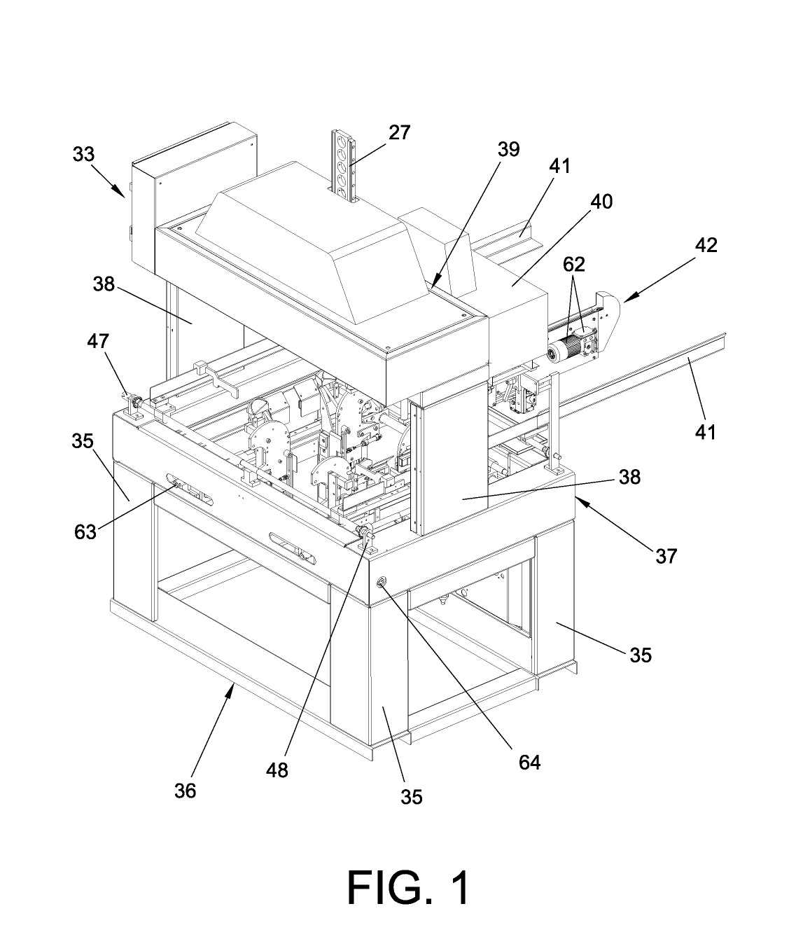

Finally, as shown in FIG. 1, the length of the mold 34 is adjusted by a pair of longitudinal spindles 63, while the width of said mold 34 is adjusted by a lateral spindle 64, these spindles 63-64 protruding through slots in the upper structure 37 of the frame 33.

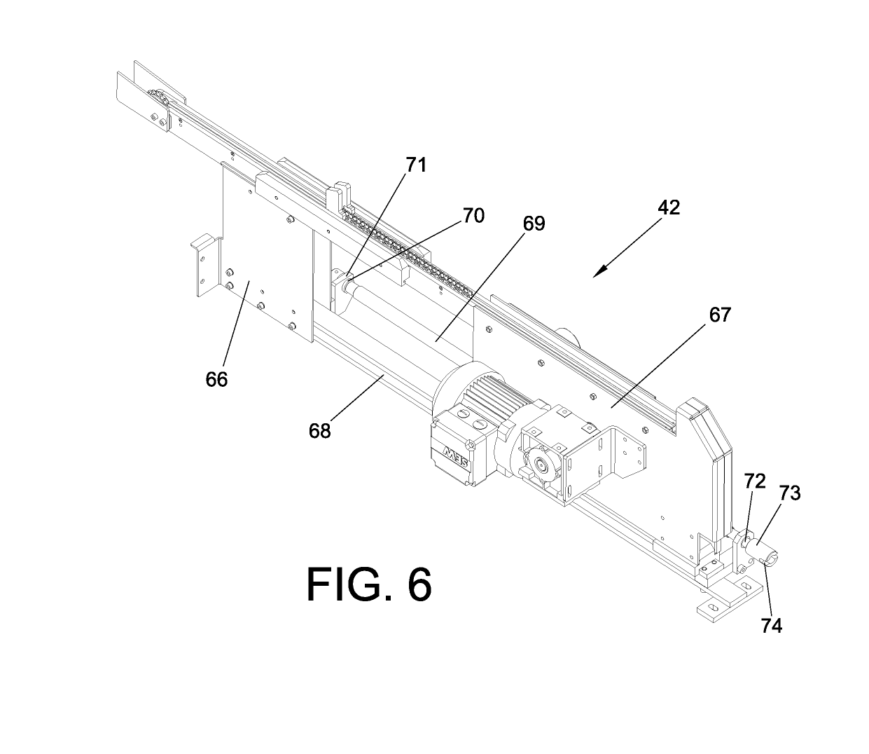

In another embodiment shown in FIG. 6, the insertion set 42 comprises a fixed part 66 and a movable part 67 that moves on a guide 68, all in order to provide cardboard sheets whose length is greater than allowed for the previous embodiments.

The movement of the movable part 67 on the guide 68 is carried out by a displacement spindle 69, where one end 70 of the displacement spindle 69 is joined to the fixed part 66 by a plate 71 positioned perpendicularly to the fixed part 66. The other end 72 of the displacement spindle 69 is attached to the movable part 67 and also comprises an end element 73.

The end element 73 comprises a diametric groove 74 adapted to receive a tool (not shown) whose rotational motion enables the mobile part 67 to move on the guide 68, thus adjusting the fixed part 66—movable part 67 distance to the length of cardboard sheet used. In this embodiment, the loading of cardboard sheets onto the insertion set 42 is carried out manually.

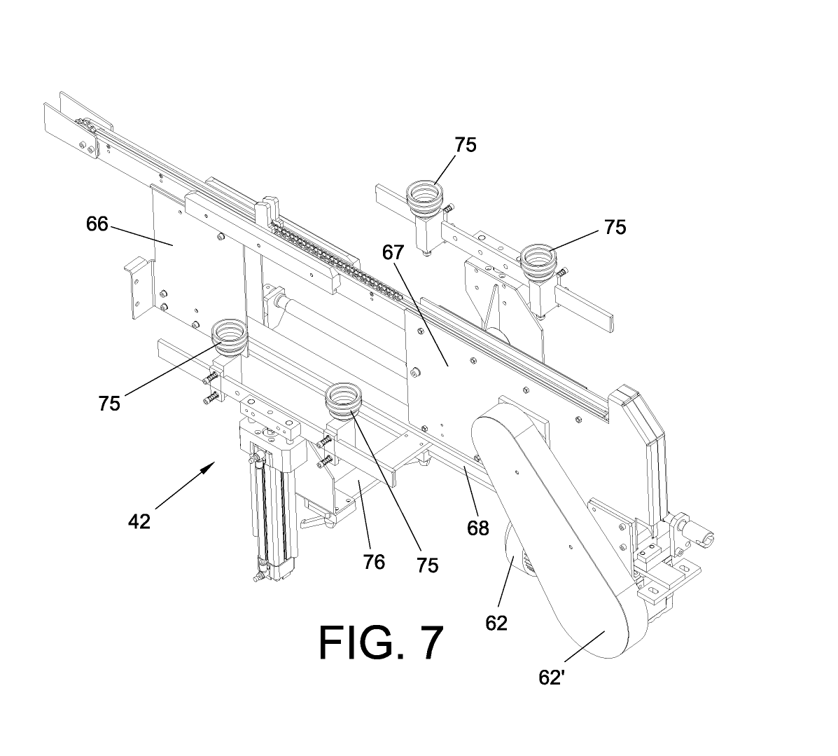

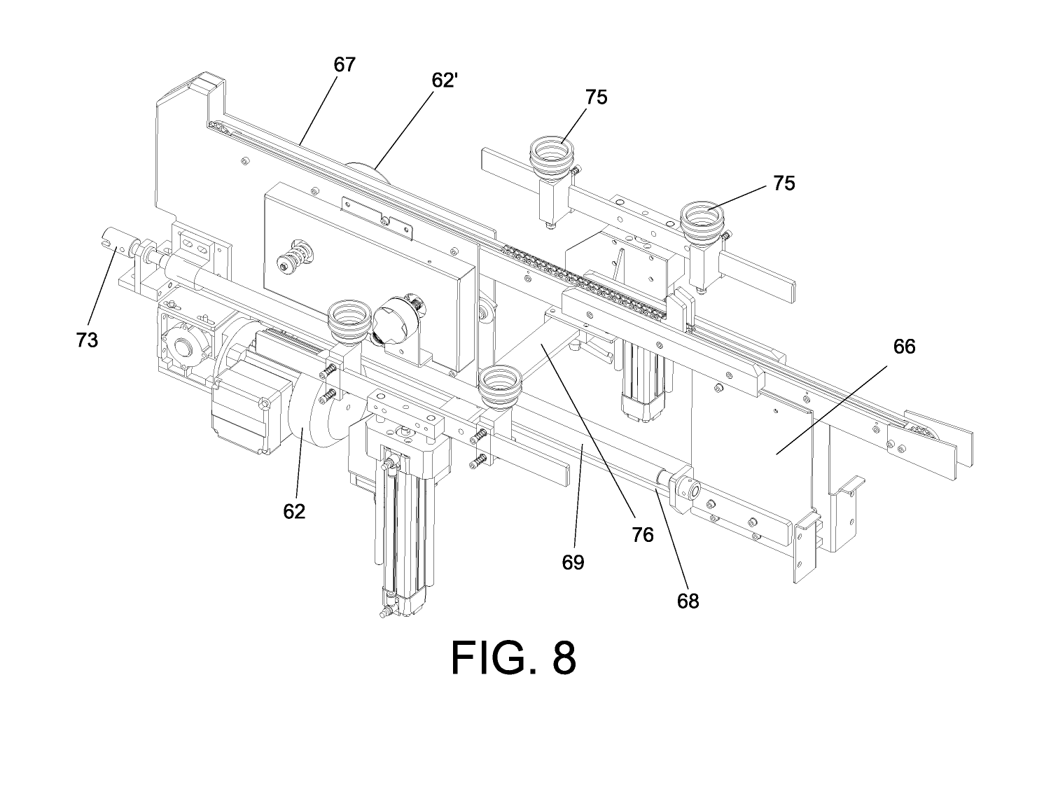

In another embodiment shown in FIGS. 7 and 8, the loading of cardboard sheets onto the insertion set 42 is performed automatically. For this, the insertion set 42 consists of all the elements described for the previous embodiment to which a further suction pads 75 set is added, said suction pads 75 set is held by a suction pad support 76 that is attached to the guide 68. In this embodiment of the invention shown in FIG. 7, the suction pads set 75 is formed by four suction pads, two on each side of the assembly formed by the fixed part and the movable part. Additionally, there is another difference between the embodiment for manual loading and automatic loading. This difference is found in the positioning of the gear motor 62. Said gear motor 62, is displaced towards the outside of the insertion set 42 to allow movement of the suction pads 75 when performing the loading of cardboard sheets. Due to displacement of the gear motor 62, the insertion set 42 further comprises a transmission system by means of a belt hidden under a cover 62′.

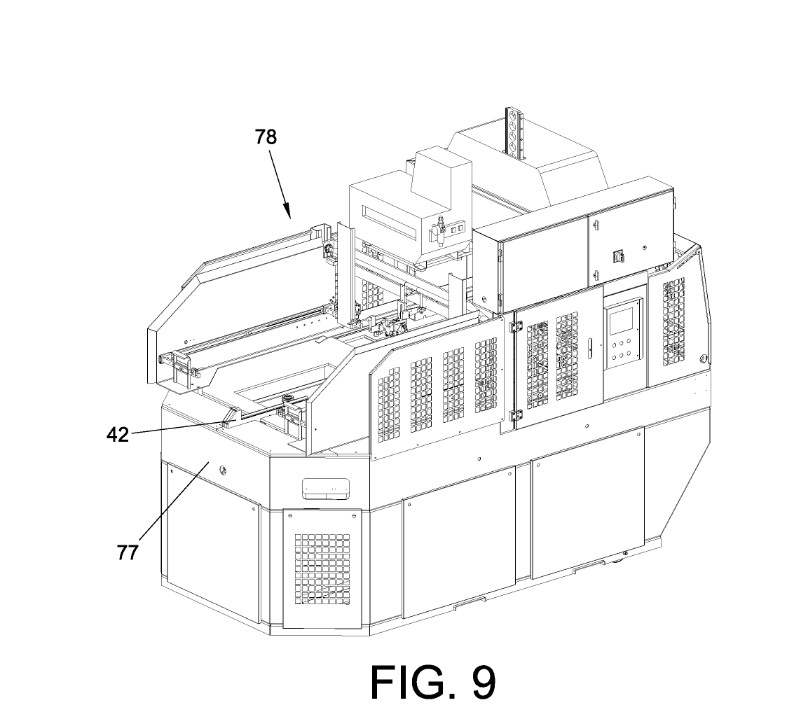

For all embodiments of the invention, the insertion set 42 may optionally be covered by a protective body to comply with existing protection regulations. An example of the machine for assembling cardboard boxes 78 of the current invention, with the insertion set 42 of automatic loading and cover body 77 is shown in FIG. 9.

1. Machine for assembling cardboard boxes, including a feeder device for feeding sheets of cardboard that are used to form the boxes in a forming station comprising an assembly device including a mold and a male element that descends by means of a vertical linear actuator, in order to form the box inside the mold co-operating with the male element, is characterized in that the machine comprises a frame (33) having a hollow surrounding structure that supports a feeder device which is removably connected to the frame (33) in a cantilevered manner.

2. Machine for assembling cardboard boxes, according to claim 1, characterized in that the frame (33) comprises a lower prismatic-rectangular part formed by four corner feet (35), a lower structure (36) and an upper structure (37), the frame (33) also comprising an upper part determined by two end supports (38) integral with the upper structure (37) and a transversal bridge (39) integral with the end supports (38), the transversal bridge (39) supporting the male element (3) and vertical linear actuator (27) set, with a part of the mold (34) of the assembly device located in the inside space of the lower part of the frame (33).

3. Machine for assembling cardboard boxes, according to claim 2, characterized in that the feeder device comprises two cantilevered side rails (41) as guides for the cardboard sheets towards the forming station, the feeder device further comprising an insertion set (42) including a drag chain (43), to which a transversal pusher (44) is attached, that drags the cardboard sheets, with said side rails (41) and insertion set (42) connected to the machine in a removable manner.

4. Machine for assembling cardboard boxes, according to claim 3, characterized in that the side rails (41) of the feeder device are fixed to sliders (45) connected to both side threads (46) of a transversal spindle (47), connecting the spindle (47), to end supports (48) fixed to the upper structure (37) of the frame (33).

5. Machine for assembling cardboard boxes, according to claim 4, characterized in that side rails (41) of the feeder device are fixed to the sliders (45) by end pieces (49) that rest on flat seats (50) of said sliders (45).

6. Machine for assembling cardboard boxes, according to claim 3, characterized in that the insertion set (42) is connected by sliding to the upper structure (37) of the frame (33) by means of side lugs (51) fitted into vertical guides (53) integral with said upper structure (37) and by means of a front upper clamp (52) linked to the frame (33) above said upper structure (37) of the frame (33).

7. Machine for assembling cardboard boxes, according to claim 3, characterized in that the positioning of the transversal pusher (44), with respect to the box forming station, consistent with the length of the cardboard sheet, adjusts said positioning by bringing the whole insertion set (42) closer or further away from the box forming station.

8. Machine for assembling cardboard boxes, according to claim 7, characterized in that the insertion set (42) of the cardboard sheet is displaced using opposite grooves (59) set on side pieces (65) of the insertion set (42), said insertion set (42) being immobilized by side knobs (60) connected to thread lugs (61) that are integral with an end section (58) and which are located in correspondence with said opposite grooves (59).

9. Machine for assembling cardboard boxes, according to claim 1, characterized in that the assembly device formed by the male element (3) and the mold (34), is circumscribed with respect to the frame (33) without protruding out of the sides of said frame (33).

10. Machine for assembling cardboard boxes, according to claim 2, characterized in that the insertion set (42) comprises a fixed part (66) and a movable part (67) that is displaced on a guide (68) to adapt the insertion set (42) to a predetermined length.

11. Machine for assembling cardboard boxes, according to claim 10, characterized in that the insertion set (42) comprises a displacement spindle (69) to carry out the movement of the movable part (67) on the guide (68).

12. Machine for assembling cardboard boxes, according to claim 11, characterized in that the displacement spindle (69) comprises a first end (70) joined to the fixed part (66) by a plate (71) positioned perpendicularly to the fixed part (66); said displacement spindle (69) comprising a second end (72) connected to the movable part (67) and which furthermore comprises an end element (73).

13. Machine for assembling cardboard boxes, according to claim 12, characterized in that the end element (73) comprises a diametric groove (74) adapted to receive a tool whose rotational motion enables the displacement of the movable part (67) on the guide (68), thus adjusting the distance between the fixed part (66) and the movable part (67) to the predetermined length.

14. Machine for assembling cardboard boxes, according to claim 13, characterized in that the insertion set (42) additionally comprises a set of suction pads (75), which is held by a suction pad support (76) connected to the guide (68).

15. Machine for assembling cardboard boxes, according to claim 4, characterized in that the insertion set (42) is connected by sliding to the upper structure (37) of the frame (33) by means of side lugs (51) fitted into vertical guides (53) integral with said upper structure (37) and by means of a front upper clamp (52) linked to the frame (33) above said upper structure (37) of the frame (33).

16. Machine for assembling cardboard boxes, according to claim 5, characterized in that the insertion set (42) is connected by sliding to the upper structure (37) of the frame (33) by means of side lugs (51) fitted into vertical guides (53) integral with said upper structure (37) and by means of a front upper clamp (52) linked to the frame (33) above said upper structure (37) of the frame (33).

17. Machine for assembling cardboard boxes, according to claim 4, characterized in that the positioning of the transversal pusher (44), with respect to the box forming station, consistent with the length of the cardboard sheet, adjusts said positioning by bringing the whole insertion set (42) closer or further away from the box forming station.

18. Machine for assembling cardboard boxes, according to claim 5, characterized in that the positioning of the transversal pusher (44), with respect to the box forming station, consistent with the length of the cardboard sheet, adjusts said positioning by bringing the whole insertion set (42) closer or further away from the box forming station.

19. Machine for assembling cardboard boxes, according to claim 6, characterized in that the positioning of the transversal pusher (44), with respect to the box forming station, consistent with the length of the cardboard sheet, adjusts said positioning by bringing the whole insertion set (42) closer or further away from the box forming station.
